(19) United States
(12) Patent Application Publication
(10) Pub. No.: US 2019/0240652 A1
(43) Pub. Date: Aug. 8, 2019

(54) METERING DEVICE AND METHOD FOR OPERATING THE METERING DEVICE

(71) Applicant: ALS Automated Lab Solutions GmbH, Jena (DE)

(72) Inventors: Gerd Bornmann, Weimar (DE); Jens Walter, Mohlsdorf-Teichwolframsdorf (DE)

(21) Appl. No.: 16/388,485

(22) Filed: Apr. 18, 2019

Related U.S. Application Data
(63) Continuation of application No. PCT/DE2017/100850, filed on Oct. 6, 2017.

(30) Foreign Application Priority Data
Oct. 18, 2016 (DE) 10 2016 119 873.0

(51) Int. Cl. B01L 3/02; G01N 35/10

(52) U.S. Cl. CPC B01L 3/0237; G01N 35/1009; B01L 2400/0487; B01L 2300/0663; B01L 2200/146

(57) ABSTRACT

A metering device for controlled receiving and/or dispensing of one or more media, includes one or more pump unit(s) and one or more control units having at least one signal input device configured to record one or more user input(s). The at least one signal input device includes one or more sensor(s) configured to detect the user input(s) and to convert the detected user input(s) into one or more measured value(s). One or more evaluation unit(s) are configured to control the pump unit(s) as a function of the measured value(s). The user input(s) is/are an action of force of a pressure change (Δp) effected by a user. In addition, a method for operating the metering device is provided.

### CROSS REFERENCE TO RELATED APPLICATIONS

This application is a continuation application of international patent application PCT/DE2017/100850, filed Oct. 6, 2017, designating the United States and claiming priority to German application 10 2016 119 873.0, filed Oct. 18, 2016, and the entire content of both applications is incorporated herein by reference.

### TECHNICAL FIELD

The disclosure relates to a metering device and to a method for operating the metering device.

### BACKGROUND

Metering devices are known in various designs for scientific and technical applications, designed as syringe pumps, diaphragm pumps, piezo pumps, or gear pumps which can be operated manually or by motor, by way of example. Furthermore, in conventional laboratory pipettes, the volumes to be pipetted are adjustable. Exchangeable pipette tips have also been part of the state of the art for years.

Manual pipetting aids, such as aspirators or pipetting balls, require actuation or at least support by the hand of a user of these pipetting aids, just as laboratory pipettes do. In order to operate known manual pipetting aids, a certain force has to be applied by the user in order to take up or dispense the volume of a medium being pipetted. If a digital pipette is used, its operation also requires the user to have a hand free.

However, some laboratory applications require that a user has both his or her hands available for the required procedures. For example, precise manipulations of tools and/or samples under a microscope can hardly be reconciled with the user performing a comparatively coarse pipetting movement with one hand. It is very difficult to coordinate the fine control of the volumes being dispensed, and at the same time to keep the position and orientation of a pipette stable—as is required, for example, in the selective removal of small particles or biological samples.

### SUMMARY

It is therefore an object of the disclosure to provide a way of manipulating samples and/or metering volumes of a medium which overcomes the disadvantages of the related art. In addition, it is an object of the disclosure to provide an improved metering device and a method for operating the metering device.

The object is achieved by a metering device and a method for operating the metering device as disclosed herein.

The metering device is configured to receive and/or discharge at least one medium in a controlled manner, and has at least one pump unit. In addition, the metering device has at least one control unit with at least one signal input device and at least one sensor configured to detect the user input and to convert the detected user input into a measured value. The metering device further includes an evaluation unit configured to control the at least one pump unit based on the measured value.

According to an aspect of the disclosure, the user input is an action of force of a pressure change caused by a user.

Aspects of the disclosure permit a sensitive operability of the metering device. For this purpose, a manner of using metering devices by the mouth of a user—which is prohibited by occupational safety law and which is avoided by technicians because of possible contamination of the medium being metered—is further developed so that there are no concerns in terms of occupational health and safety of the user, nor in regards to a risk of contamination of the medium.

Suitable media include fluid and gaseous media, as well as suspensions, dispersions, colloids, foams and mixtures thereof—to the extent that these media can be taken up/received, and in particular suctioned, or discharged, in particular ejected, by the pump unit owing to their fluidity.

The pressure change in an exemplary embodiment of the metering device is a change in the air pressure at the signal input device of the control unit. For this purpose, the signal input device can be provided with a hose, and optionally with a mouthpiece. A user of the metering device blows into or sucks on the mouthpiece, thereby causing a pressure change which manifests itself as higher pressure and/or lower pressure.

In further exemplary embodiments of the metering device, the change in the pressure force is caused by the user biting on a force sensor. In this case, for example, the magnitude of the biting force and/or its duration or sequence can be detected and converted into at least one input value. The force sensor can be arranged in an exchangeable envelope in order to fulfill hygiene requirements—in particular, upon a change in user. For the same reason, the mouthpiece is optionally interchangeable.

By way of example, instead of a biting force, the tensing—and accordingly, the relaxation—of a muscle or a group of muscles can be detected as an action of force applied to a sensor as a result of a pressure change. For example, a corresponding sensor which is configured to detect muscle contractions and relaxations can be attached to an arm or leg of the user.

Since a biting force or a muscle tensioning can be applied only in one direction, possible further developments of the metering device allow for issuing an additional command which enables a modification of the control command in a manner which encodes a resulting flow direction of the medium, and thus whether the medium is received or discharged.

In further exemplary embodiments of the metering device, a user input can be based on detecting a movement with no counter force—for example, the movement of a finger. Different gestures can represent different functions in this case. The detected gestures are converted by a suitable device into an action of force.

In an exemplary embodiment which is advantageous because it is easy to implement, a voice command is issued by the user before changing the pressure force. This voice command can be stored in a suitable memory of the metering device. The voice command can be predetermined or predefined by the respective user. By way of example, a microphone is present to capture the voice command. The control unit is configured in a manner which enables a logical linking of the detected voice command and a change in the pressure force.

In further exemplary embodiments, the metering device has a manipulation unit which is connected to the pump unit in such a way that the medium is moved or is movable by the pump unit at least along sections of the manipulation unit. The connection between the pump unit and the manipulation unit is of a fluidic design, and allows a hydraulic or pneumatic connection of the two according to the medium.

In one exemplary embodiment of the metering device, the manipulation unit includes a media line—for example, in the form of a channel or hose—and an end piece.

In order to be able to manipulate a sample—for example, particles of a material, cells or tissue in a suspension, or a tissue—with the manipulation unit, the end piece is configured as a grip piece.

A capture region for receiving a tip—or in general, a tapered tube section—can be formed on the end piece. As such, the capture region can be shaped as a cone on which a commercial pipette tip can be placed. “Tip” and “pipette tip” are used below as synonymous terms, unless expressly stated otherwise. It is also possible for the end piece and/or the manipulation unit to be configured with an ejection device for ejecting the pipette tip—as is known with hand-operated laboratory pipettes, for example.

The tip is, for example, a conventional replaceable pipette tip for single or multiple use, a capillary or a cannula, for example made of plastic, metal or glass.

In a further exemplary embodiment, the tip can be fixed and non-detachable, or attached to the manipulation unit in a manner allowing manual or automatic replacement.

In a further exemplary embodiment of the metering device, a media reservoir is provided, which is in fluid communication with the manipulation unit, to permit the medium to be transported at least between the end piece and the media reservoir by the controlled pump unit.

According to the setting of the control unit and the settings of the metering device specified by the user, the medium can be received or discharged in predefined volumes and/or time durations. It is also possible to receive or discharge the medium during individually selectable durations and/or in individually selectable volumes.

For example, for the discharge of predefined volumes, it is possible to arrange drops of defined size and volume on a surface.

For example, a volume flow can be used to extract impurities from a sample.

A defined negative pressure can be used to hold particles with a defined force on the pipette tip.

In an exemplary embodiment of the metering device, the control unit is provided with a parameter list and/or database entries which contain specific selectable operating parameters for different media. Depending on which medium is currently being received and/or discharged, the operating parameters of the metering device are adjusted to the properties of the medium—for example, the pressure generated by the pump unit, switching times, switching delays, and any pre- and post-operation delays.

In addition, current operating conditions, such as ambient temperature, temperature of the medium, and ambient pressure can be detected. The current operating parameters can be modified according to the current operating conditions to support a precise manipulation of objects and/or samples. By way of example, unwanted capillary effects of the pipette tip and/or the media line can be reduced by taking into account a current temperature of the medium, which influences the viscosity of the medium.

A database can be stored in the control unit or connected to the control unit by a data connection suitable for the transmission of data.

The control unit can be connected to a user interface or may include such a user interface. For example, a further device, for example a sensor, can be connected to the user interface in such a way that data can be exchanged between the control unit and the connected device. Thus, in one exemplary embodiment of the metering device, a camera and/or a microphone can be provided and connected to the control unit via the user interface. The connection between the user interface and the control unit can be realized by cable or wirelessly—for example, by radio.

It is also possible that a signal amplification factor is provided to the control unit, for example. This can be preset or, by way of example, selected individually by the user. Such an option increases the individual ease of use and the sensitivity of the metering device—in particular, the manipulation unit.

In addition or as an alternative, at least one further parameter can be pre-set for the control unit. With regard to the medium being processed in each case, the quantity of the medium to be received or discharged, or the corresponding volume of the medium, a volume flow of the medium, and a working pressure which is generated by the pump unit can be predefined.

In further exemplary embodiments of the metering device, a valve block is installed between the pump unit and an end piece of the manipulation unit. It enables, for example, working in one pumping direction until a medium held in the media reservoir is fully expended.

The pump unit can be a gear pump, a peristaltic pump, a syringe pump, a piezo pump, a diaphragm pump, a piston pump, or a spiral pump. It can also be embodied as at least two syringe pumps which are actuated either by the same drive or by separate drives.

The structure of the pump unit can be of various designs. For example, there can be at least two pumps which generate a flow of media in opposite directions. The two pumps can be switched on and off separately as needed. Alternatively, at least one pump can also be operated in two directions. As such, the medium can be conveyed successively in opposite directions by means of one pump.

If at least two (syringe) pumps are used, they can be designed, or can be controlled, to function in fluidically inversely directions. This makes it possible to take up or discharge more than one volume—for example, of a syringe pump—without interruption. This is made possible by switching from one of the syringe pumps to the other syringe pump when the end of a stroke is reached. In such an exemplary embodiment, at least one partially filled syringe pump is available at all times. At the point in time when the end of a pump stroke is reached, one of the syringe pumps is empty while the other is full.

Alternatively, at least one syringe pump can be kept in a standby position. When the pump stroke of one syringe pump is completed, the further conveyance of media is taken over by the syringe pump which was previously in the standby position. The previously emptied syringe pump can now be brought into the standby position.

The pumping action can be generated according to further exemplary embodiments by vacuum and/or overpressure systems. These can act on the medium via at least one valve within the metering device, thereby conveying the medium. Valves can be, by way of example, proportional valves and/or pulsed barrier valves or multi-way valves.

The metering device can be a multi-channel device. Several aspirations and/or discharges of at least one medium are possible with one user input. As such, a user input in the control unit can result in the output of a control command to several pump units.

It is also possible that a user input results in the output of control commands which are different for different pump units. By way of example, different volumes and/or media are received or discharged by the different pump units.

A metering device according to an aspect of the disclosure can be used for suctioning objects onto the manipulation unit and/or for holding the same on the manipulation unit (so-called patching). For example, by receiving and/or aspirating medium from a sample space—for example, from a Petri dish with a cell suspension—the same can be suctioned into the manipulation unit. With the negative pressure generated in this way, a selected object of the cell suspension—for example, a cell selected by the user with a microscope—can be suctioned to the manipulation unit and held on or in its opening.

The strength of the negative pressure is advantageously chosen or adjusted so that the object is held securely, but not damaged.

In the metering device, a medium can be present as a system fluid which is immiscible with a sample medium in which, for example, cells are situated. The medium acting as a system fluid is transported only a limited distance to generate a negative pressure or an overpressure at the opening of the end piece, such that it does not escape from the manipulation unit to the outside. In a further exemplary embodiment, the system fluid is delimited from the environment in the region of the end piece by, for example, an air-permeable filter.

The metering device can furthermore be used for mixing and/or metering various media.

The metering device according to an aspect of the disclosure as described above, and further metering devices, can be operated by a method in which a user input in the form of a pressure change is generated at a signal input device of a control unit of the metering device. The user input is detected by suitable sensors. Subsequently, the detected user input is converted into a measured value and a control command is generated as a function of the measured value. A pump unit is actuated by the control command. The actuated pump unit is used for generating a pressure difference in a manipulation unit and for receiving or discharging a medium into and/or out of the manipulation unit.

In order to reduce adverse physical and/or physico-chemical effects, in an exemplary embodiment of the method, a base volume flow and/or base pressure of the medium is set and generated in the manipulation unit. The base volume flow is set in such a manner that it opposes capillary forces which occur at least in sections of the manipulation unit.

An adjustment of the base volume flow and/or base pressure can be done manually—for example, by a rotary or slide control—or automatically.

The metering device according to an aspect of the disclosure and the method according to an aspect of the disclosure make it possible for users—for example, employees of a laboratory—to be protected not only legally but also technically from unwanted uptake of media into the mouth. At the same time, a sensitive and precise manipulation of the sample and/or objects is preserved. A further advantage of the disclosure is the prevention of contamination of the medium, the sample and/or the objects by the user.

### BRIEF DESCRIPTION OF THE DRAWINGS

The disclosure will now be described with reference to the drawings wherein:

FIG. 1 shows a schematic illustration of a metering device according to a first exemplary embodiment the disclosure,

FIG. 2 shows a schematic illustration of the metering device according to a second exemplary embodiment the disclosure,

FIG. 3 shows a flowchart of a method according to a first exemplary embodiment of the disclosure, and

FIG. 4 shows a flowchart of the method according to a second exemplary embodiment of the disclosure.

### DESCRIPTION OF EXEMPLARY EMBODIMENTS

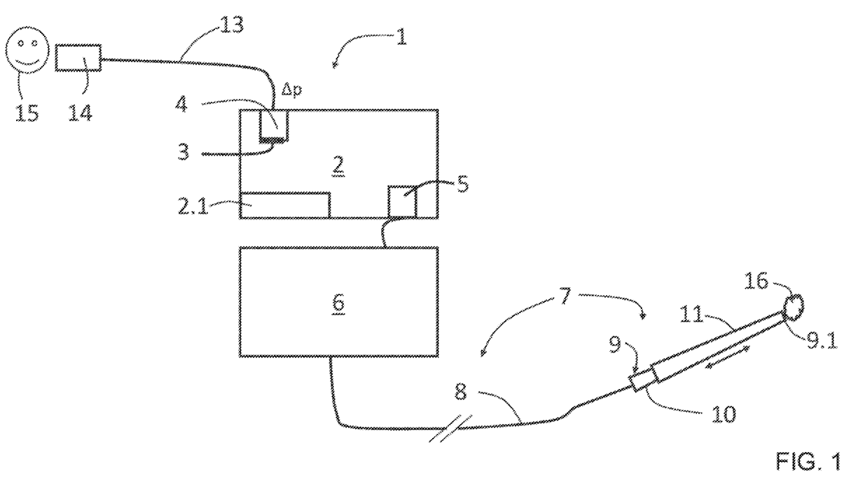

A metering device 1 shown schematically in FIG. 1 includes a control unit 2, a pump unit 6, and a manipulation unit 7.

The control unit 2 has a signal input device 4 with a sensor 3 configured to detect forces resulting from pressure changes Δp, and an evaluation unit 2.1. A signal output 5 of the control unit 2 is connected via a data cable to the pump unit 6, wherein the pump unit 6 can be actuated by a control command generated by the control unit 2 and output via the signal output 5.

The manipulation unit 7 is connected to the pump unit 6, and includes in this exemplary embodiment a media line 8 and an end piece 9.

A portion of the outer surface of the end piece 9 is a capture region 10 configured to capture and hold in a detachable manner (symbolized by the double arrow) a tip 11 in the form of a pipette tip, a cannula, or a capillary.

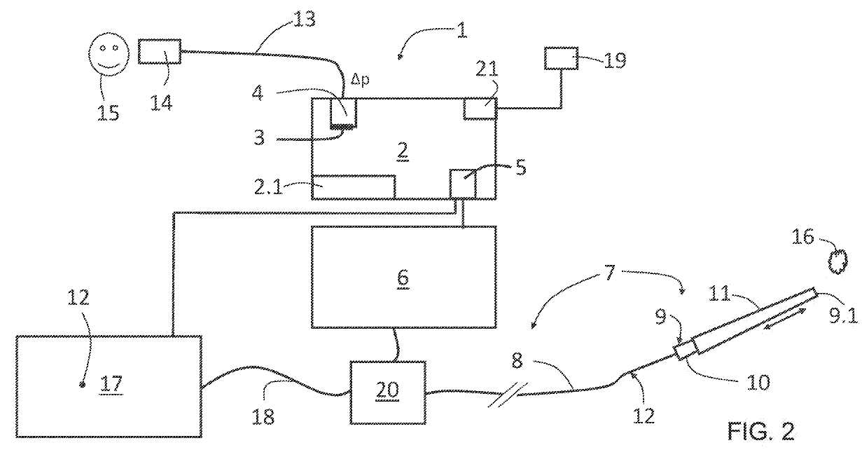

By the pump unit 6, a medium 12 (see FIG. 2) can be pumped through the media line 8, wherein a conveying direction of the medium 12 can be selected by the actuation of the pump unit 6 by the control unit 2.

In further exemplary embodiments of the metering device 1, the end piece 9 is provided with an ejector (not shown), which serves for stripping the tip 11 from the capture region 10 when it is no longer needed or when it is changed.

A hose 13 is attached at the signal input device 4, bearing a mouthpiece 14 on its free end.

A symbolically represented user 15 blows into the mouthpiece 14 to generate an overpressure at the signal input device 4. In contrast, if the user 15 applies suction to the mouthpiece 14, a pressure change Δp moves towards a negative pressure at the signal input device 4.

The pressure change is detected by the sensor 3 at the signal input device 4 as a measured value of a pressure force, and converted by the control unit 2 into a control command which is transmitted via the signal output 5 to the pump unit 6.

This conveys a medium 12 in the media line 8 in accordance with the received control command. If the medium 12 is pumped in the direction of the end piece 9, an overpressure is generated at the opening 9.1 of the endpiece 9. If, on the other hand, the medium 12 is suctioned in by the pump unit 6, a negative pressure is created at the opening 9.1. This can be used, for example, to hold an object 16 on or in the opening 9.1 and/or in the attached tip 11.

In further exemplary embodiments of the metering device 1, a plurality of control units 2, pump units 6, manipulation units 7 and/or media lines 8 is included.

In the second exemplary embodiment of the metering device 1 shown in FIG. 2, a media reservoir 17 in which the medium 12 is held is additionally included. The media reservoir 17 is connected via a feed line 18 to a valve block 20 which is installed between the pump unit 6 and the end piece 9 in the media line 8.

A user interface 21 of the control unit 2 is connected to a microphone 19.

The valve block 20 can also be actuated by the control unit 2. In a first mode, the valves of the valve block 20 are switched so that the metering device 1 is operated as described for FIG. 1.

In a further operating mode, the valve position is adjusted in such a manner that the medium 12 is pumped out of the media reservoir 17 via the feed line 18 into the valve block 20 and further to the end piece 9.

The medium 12 contained in the media reservoir 17 can be a system fluid which serves only to generate overpressure or underpressure at the opening 9.1 of the end piece 9, and is not discharged to the environment.

The media reservoir 17 can contain a medium 12 which is discharged to the environment—for example, to a sample space located in front of the opening 9.1.

In a further exemplary embodiment, the medium 12 is suctioned from the sample space into the media reservoir 17.

When the pumping action of the pump unit 6 is reversed, medium 12 can be pumped from the end piece 9 to the media reservoir 17.

In further exemplary embodiments of the metering device 1, a pressure or force sensor is installed in the mouthpiece 14. If the user 15 bites on this pressure sensor, the biting force is detected as a measured value of a pressure change and transmitted to the signal input device 4. In addition, in such an exemplary embodiment, a microphone 19 can be included to detect one or more voice commands and to transmit to the control unit 2.

Voice commands can be used to select a transport direction of the medium 12, while the aspirated or discharged quantity or volumes of the medium 12 can be controlled according to the detected measured value of the pressure change, by way of example.

It is also possible that when a pressure change is detected, a preset amount of the medium 12 is received or discharged.

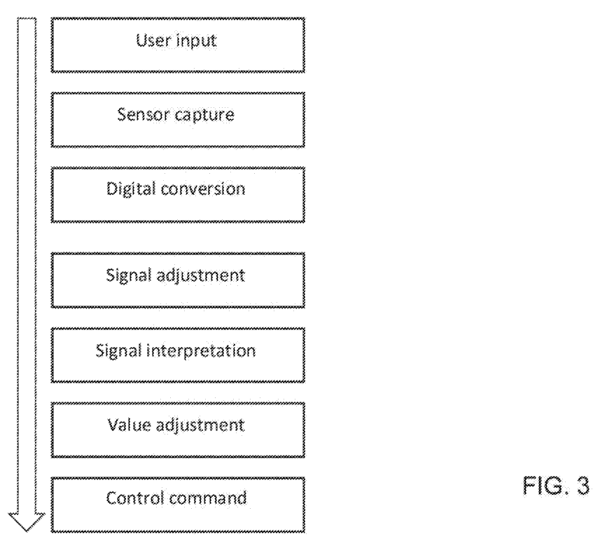

The sequence of the method in a possible exemplary embodiment is shown schematically in FIG. 3. The arrow symbolizes the sequence of the method steps. The flow parameters implemented in the metering device 1 are controlled in an analog manner.

The user input, which can be made by blowing and/or suctioning on the mouthpiece or by biting on a force sensor, is detected by a sensor 3. The sensor is, for example, a pressure sensor with an output range from 0 to 5 V as measured values.

In the course of a digital conversion, the detected and outputted measured values are translated into a value range from, for example, 0 to 2048. By translating the optionally analog measured value into a dimensionless digital value, the user input is prepared and scaled for further processing in a control unit. By mapping possibly different input variables of the sensors to a digital value of, for example, 11-bit data width (0 to 2048), the input values of the control are normalized, which makes it possible to use the same control algorithms and parameters for different system configurations.

An adaptation of the converted measured value takes place, for example, as a gain or attenuation depending on the pre-settings of the control unit and/or the individual settings of the user.

The measured value is interpreted as a function of the pre-settings—for example, as a volume flow, volume, and/or pressure.

In the step of the value adjustment, control loops and detected current operating parameters are incorporated and, for example, volume and conveying speed are matched with operating data of the pump unit—for example, with regard to the stroke to be traveled and the stroke speed.

The control command is generated as a result of the preceding steps and output at the signal output 5.

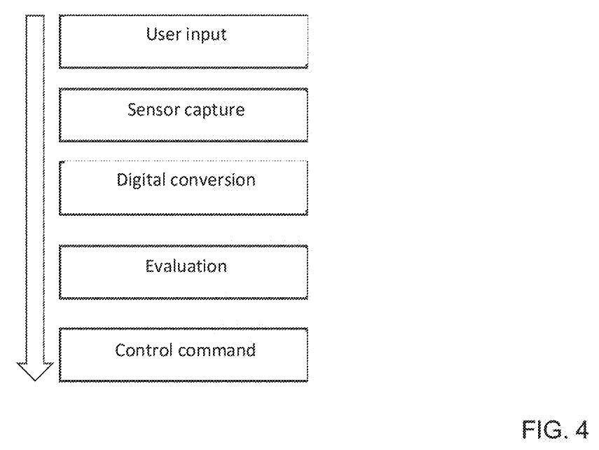

In a further exemplary embodiment illustrated in FIG. 4, a triggered command execution is shown.

Again, user input is done by blowing and/or suctioning on the mouthpiece or by biting the force sensor. The sensory detection and the digital conversion is carried out as described for FIG. 3.

In the step of the evaluation, a verification is made to see whether a predetermined threshold value has been reached or exceeded by the detected and/or converted measured value.

The criterion is, for example, the converted measured value exceeding the threshold value. If the user has made the pressure change strongly enough, and it can therefore be ruled out that it is merely a fluctuation of the ambient pressure—for example, due to an air flow or a ventilation system—the converted measured value is accepted and the control command is generated and output.

The content of the control command is predetermined. Only its generation and output are triggered by the user input. For example, due to the control command, a volume of 10 μl is dispensed with a volume flow of 1 μl/s, with a pressure surge.

Alternatively, a corresponding volume is aspirated by a vacuum surge.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 metering device
2 control unit
2.1 evaluation unit
3 sensor
4 signal input device
5 signal output
6 pump unit
7 manipulation unit
8 media line
9 end piece
9.1 opening (of the end piece)
10 capture region
11 tip
12 medium
13 tube
14 mouthpiece
15 user
16 object
17 media reservoir
18 feed line
19 microphone
20 valve block
21 user interface

What is claimed is:

1. A metering device for at least one of receiving and discharging a medium in a controlled manner, the metering device comprising:
a pump unit; and
a control unit including a signal input device and an evaluation unit, the signal input device including a sensor configured to detect a user input and to convert the user input into a measured value, the evaluation unit being configured to control the pump unit as a function of the measured value, and the user input being an action of a force of a pressure change caused by a user.

2. The metering device according to claim 1, wherein the pressure change is at least one of a change in an air pressure or a change in a pressure force at the signal input device.

3. The metering device according to claim 1, further comprising:
a manipulation unit connected to the pump unit to permit the medium to be moved by the pump unit at least along sections of the manipulation unit.

4. The metering device according to claim 3, wherein the manipulation unit includes a media line and an end piece.

5. The metering device according to claim 4, wherein a capture region configured to capture a pipette tip is formed on the end piece.

6. The metering device according to claim 5, further comprising:
a media reservoir connected fluidically to the manipulation unit to permit the medium to be transported between the end piece and the media reservoir by the pump unit.

7. The metering device according to claim 1, wherein the control unit is assigned at least one of a parameter list and database entries containing specific, selectable operating parameters for different media.

8. A process of suctioning objects with a metering device, the process comprising:
suctioning the objects onto a manipulation unit; and
holding the objects on the manipulation unit.

9. The process of claim 8, further comprising:
suctioning the objects into the manipulation unit; and
holding the objects in the manipulation unit.

10. The process of claim 8, further comprising:
mixing and metering a plurality of media with the metering device.

11. A method of operating a metering device, the method comprising:
generating a user input, the user input being a pressure change at a signal input device of a control unit of the metering device;
detecting the user input by a sensor of the signal input device;
converting the user input into a measured value;
generating a control command as a function of the measured value;
actuating a pump unit by the control command;
generating a pressure difference in an manipulation unit by the pump unit; and
at least one of receiving or discharging a medium at least one of in or out of the manipulation unit.

12. The method according to claim 11, wherein at least one of a base volume flow or a base volume pressure of the medium is set and generated in the manipulation unit to permit the at least one of the base volume flow or the base volume pressure to oppose capillary forces arising at least in sections of the manipulation unit.
